(19) United States
(12) Patent Application Publication
(10) Pub. No.: US 2026/0105591 A1
(43) Pub. Date: Apr. 16, 2026

(54) MACHINE AND METHOD FOR WORKING AND/OR MOVING METAL PLATES OR SHEETS COMPRISING EDGE RECOGNITION MEANS

(71) Applicant: SALVAGNINI ITALIA S.P.A., Sarego (VI) (IT)

(72) Inventors: Gianmarco VISENTIN, |sarego (Vl) (IT); Francesco MALAPELLE, |sarego (Vl) (IT); Gianfranco NARDETTO, |sarego (Vl) (IT)

(21) Appl. No.: 19/116,722

(22) PCT Filed: Sep. 28, 2023
(86) PCT No.: PCT/IB2023/059677

§ 371 Date: Mar. 28, 2025

(30) Foreign Application Priority Data
Sep. 30, 2022 (IT) 102022000020220
Sep. 30, 2022 (IT) 102022000020226

(51) Int. Cl. G06T 7/00; G06T 7/13; G06V 10/20; G06V 10/26; G06V 10/70

(52) U.S. Cl. CPC G06T 7/001; G06T 7/13; G06V 10/255; G06V 10/273; G06V 10/70; G06T 2207/20081; G06T 2207/30136; G06T 2207/30164; G06V 2201/06

(57) ABSTRACT

A machine for working and/or moving metal pieces has an operating system, an artificial vision system with a camera to acquire an image of at least one piece, a control unit to control the operating system, and a processing unit for processing the image with a Deep Learning algorithm or a contour recognition algorithm depending on whether the contour stretch is precisely and completely delineated, extracting geometric information of the piece based on the contour stretch with reference to a reference system of the machine and sending the geometric information to the control unit to configure operating parameters of the operating system.

The invention relates to machines and methods for working and/or moving sheets metal and/or metal plates and in particular relates to a machine for working and/or moving sheets metal and/or metal plates, semi-finished products, scrap, that is provided with an artificial vision system adapted to detect geometric information, such as position and orientation, of the pieces to be worked, and capable of setting optimal operating parameters for the operating means that work and/or move the pieces. The invention also relates to a method for working and/or moving sheets metal and/or metal plates based on geometric information about the pieces detected by an artificial vision system.

Machines for working and/or moving whole or portions of sheets metal and/or metal plates are known, such as laser cutting machines, punching machines, combined cutting and punching machines, bending machines, transfer and manipulating machines (e.g. Cartesian manipulators, transfer belts, etc.) provided with artificial vision systems that are used to determine the position and orientation of pieces or parts of sheet metal or metal plate to be worked and/or moved, so as to allow a control unit of the machine to adapt and configure the operating parameters, i.e. the working and/or moving programs, so as to appropriately control the operating means that perform the working, for example the cutting and/or punching and/or bending means or means that move or manipulate the pieces.

The pieces to be worked typically comprise sheets metal and/or metal plates, sometimes scraps or skeletons of sheet metal or metal plates which can be used to produce other pieces.

Known artificial vision systems used for this purpose comprise a camera capable of taking a photo or image of the piece or pieces to be worked and/or moved.

A processing and calculating unit of the artificial vision system processes the image acquired by the camera by means of an suitable contour extraction algorithm so as to extract and extrapolate in a processed image a contour of the piece, i.e. the line or the set of lines that limit and circumscribe the piece.

In some applications, the extrapolated contour is compared with a previously saved reference figure or drawing of the same piece so as to obtain geometric information about the alignment of the piece on the work plane with reference to a reference system of the machine.

The alignment information includes in particular an offset, or distance, and a rotation of one or more contour stretches, in particular substantially rectilinear, of the piece represented in the processed image with respect to the corresponding contour stretch of the piece represented in the reference figure. In this way, it is possible to determine position and orientation of the piece with respect to the reference system of the machine. “Position” of the piece means, for example, a distance of a reference point of the piece (typically an edge or angle) from the origin of the machine reference system the along two orthogonal axes, while “orientation” of the piece means an angle formed by a reference stretch of piece contour with one of the two axes of the reference system.

The geometrical information relating to position and orientation of the piece thus obtained is sent to the control unit of the machine which uses the information to adapt and configure the working parameters, i.e. the working programs and then suitably control the operating means that perform the working, for example cutting and/or punching and/or bending, or the means that move and manipulate.

A drawback of said known working and/or moving machines and the relating working and/or moving methods is that the contour extraction algorithms are often unable to precisely and completely recognize and identify the contour of the piece, and in particular are unable to distinguish all contour stretches from the background, i.e. from the work plane, typically due to low contrast with the background, surface finish, material type, colouration of the piece, and/or due to lighting conditions and/or position of the piece with respect to the camera (perspective), etc.

Furthermore, said artificial vision systems do not allow determining alignment and positioning of scraps or skeletons of sheet metal or metal plate for which reference figures or drawings to be compared are not available.

In both cases, an operator is therefore required to intervene through control panel and manually select the necessary points on the processed image of the piece that allow the artificial vision system to identify the missing or insufficiently represented contour stretches of the piece.

However, this manual identification procedure, in addition to requiring the intervention of an experienced operator, is quite laborious and time-consuming and in any case can be subject to errors.

An object of the present invention is to improve the known machines and methods for working and/or moving sheets metal and/or metal plates.

Another object is to provide a machine and a method that allow determining position and orientation of pieces arranged on a work plane of the machine in a precise, accurate and substantially automatic way, and then configuring and/or adjusting the operating parameters of operating means that work and/or move/manipulate the pieces.

A further object is to provide a machine and a method that allow determining at least a position and an orientation on the work plane of the machine of pieces comprising sheets metal, metal plates, semi-finished products, scraps or skeletons of sheets metal or metal plates, in particular without the need to process and save reference figures or drawings of said pieces.

Another object is to provide a machine and a method that allow determining geometric information of pieces to be worked, in particular comprising at least distances and rotation angles of one or more contour stretches of the pieces.

In a first aspect of the invention a machine for working sheets metal and/or metal plates according to claim 1 is provided.

In a second aspect of the invention a method for working sheets metal and/or metal plates according to claim 8 is provided.

In a third aspect of the invention a machine for working sheets metal and/or metal plates according to claim 15 is provided.

In a fourth aspect of the invention a method for working sheets metal and/or metal plates according to claim 22 is provided.

The invention can be better understood and implemented with reference to the attached drawings which show exemplary and non-limiting embodiments thereof, wherein:

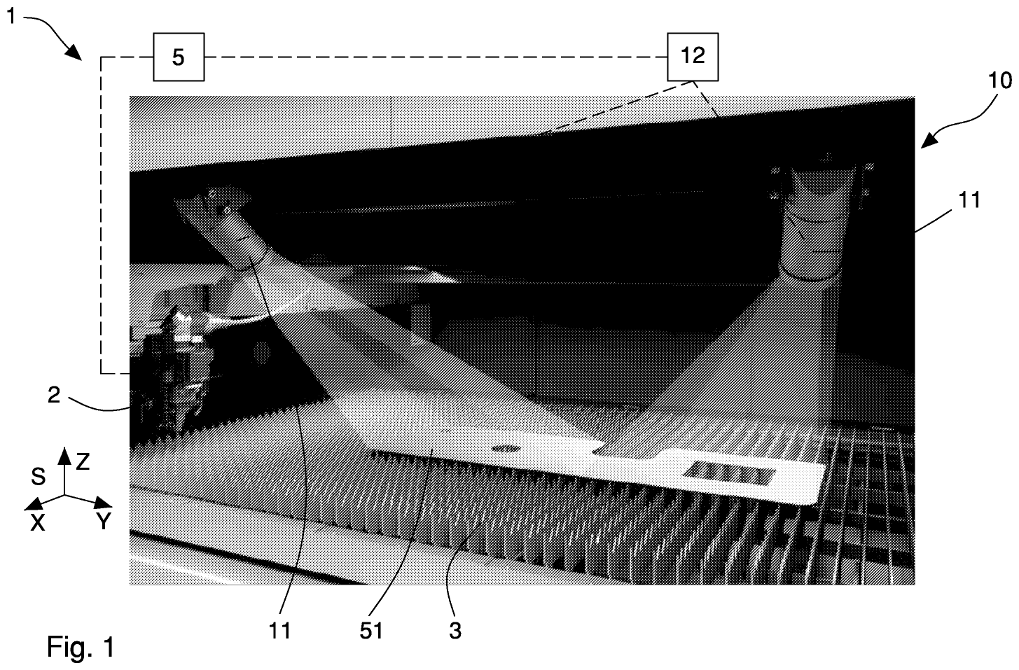

FIG. 1 is a partial view of the machine for working and/or moving sheets metal and/or metal plates of the invention associated with a piece to be worked, in particular a semi-finished piece, arranged on a work plane of the machine;

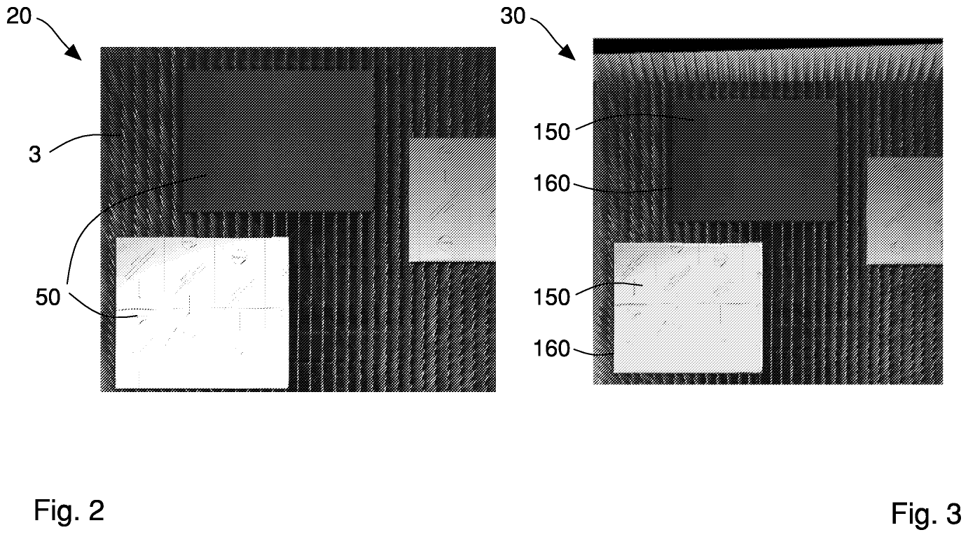

FIG. 2 is an image of pieces, in particular new sheets metal, arranged on the work plane of the machine, said image being acquired by a camera of an artificial vision system of the machine of FIG. 1;

FIG. 3 is a processed image obtained by a processing unit of the machine by processing the image of FIG. 2 by a Deep Learning algorithm;

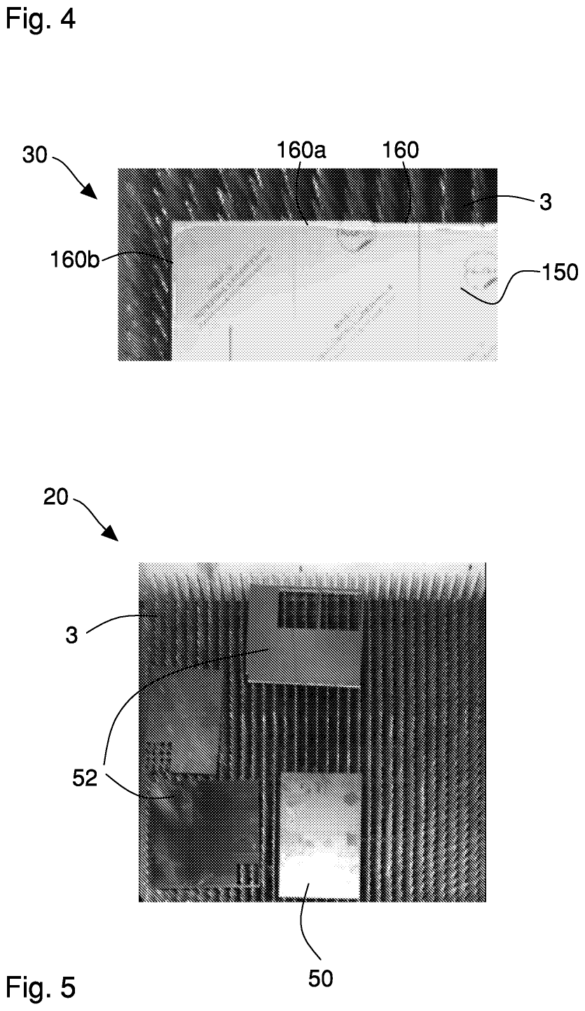

FIG. 4 is an enlargement view of the processed image of FIG. 3 illustrating contour stretches of a contour of a piece;

FIG. 5 is an image of further pieces to be worked positioned on the work plane of the machine, said image being acquired by the camera of the artificial vision system of the machine of FIG. 1;

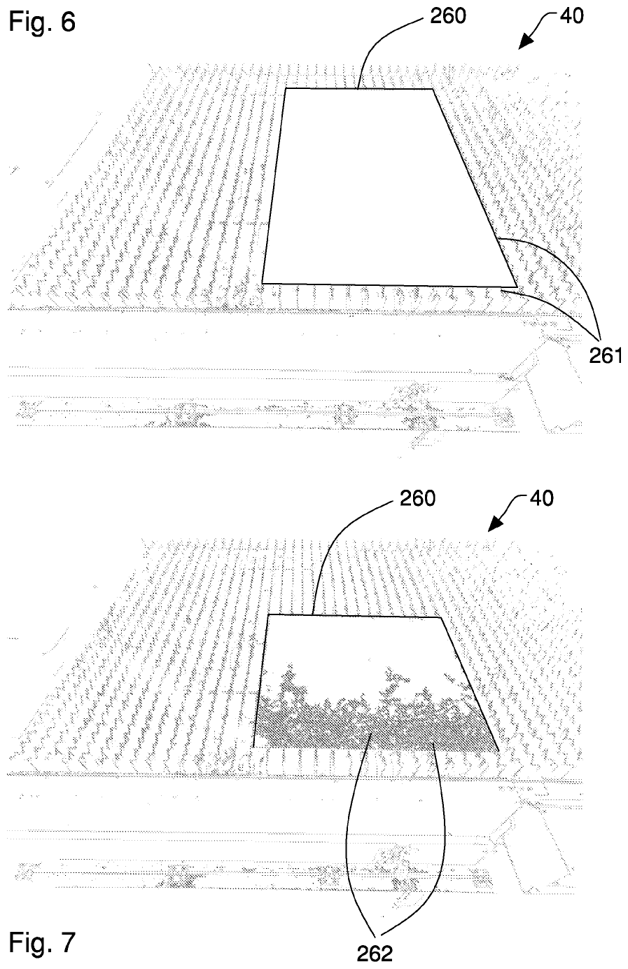

FIG. 6 is a perspective view of processed image of a piece, in particular a sheet metal, processed by a contour recognition algorithm;

FIG. 7 is a perspective view of a processed image of another piece, in particular a sheet metal, processed by a contour recognition algorithm;

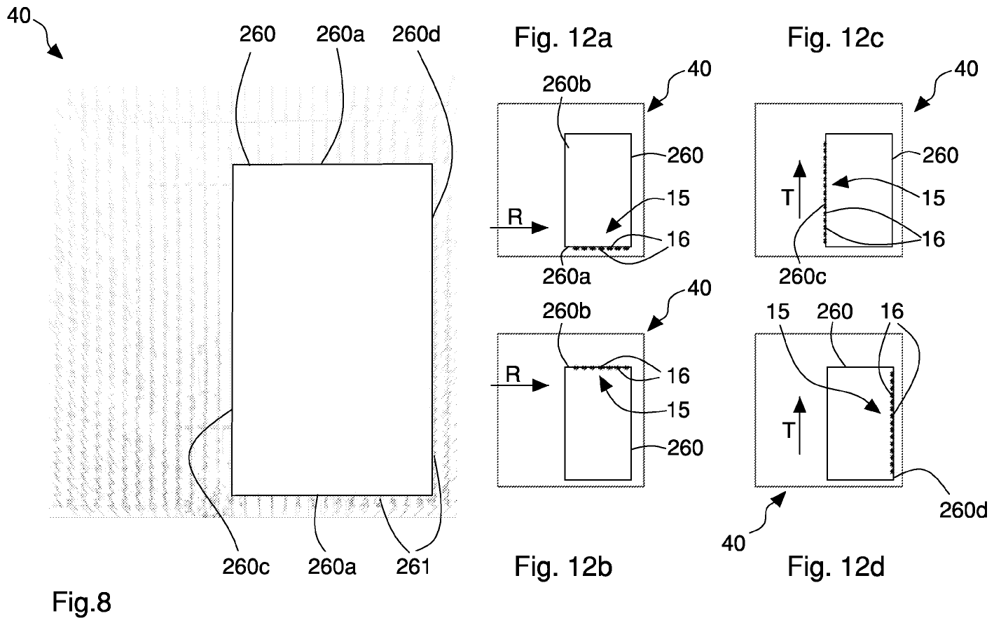

FIG. 8 is a plan view of a processed image, obtained by straightening the image of FIG. 6;

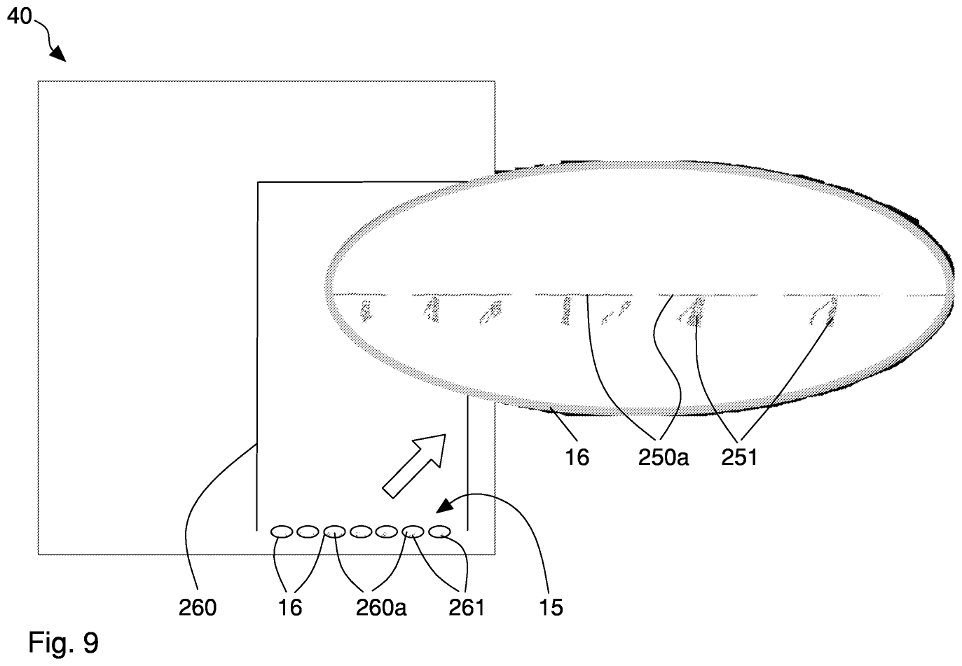

FIG. 9 shows mask means comprising a plurality of elliptically shaped masks applied to a portion of the processed image of FIG. 8 containing a contour stretch to be recognized and identified, and an enlarged view of one of said masks containing a portion of the contour stretch;

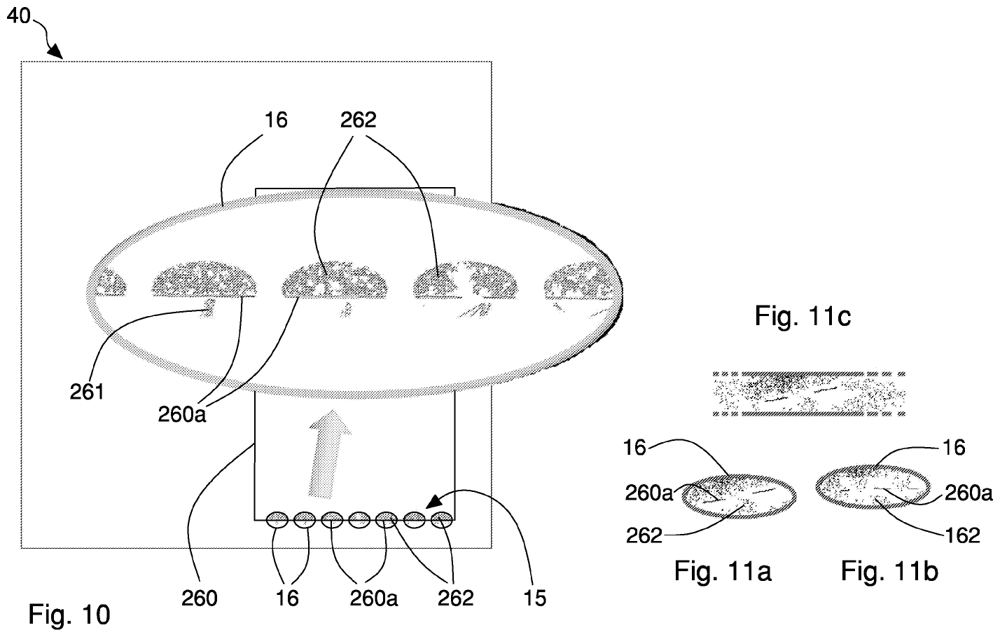

FIG. 10 shows mask means comprising a plurality of elliptically shaped masks applied to a portion of a processed image, obtained by straightening the image of FIG. 7, containing a contour stretch to be recognized and identified, and an enlarged view of one of said masks containing a portion of the contour stretch;

FIGS. 11a-11c show respective enlarged views of two elliptical-shaped masks enclosing respective portions of a contour stretch and of a rectangular-shaped mask that encloses a portion of a contour stretch and which is not an object of the present invention;

FIGS. 12a-12d show the plurality of masks of the mask means arranged along detection lines and superimposed on contour stretches respectively horizontally upper and lower, vertically left and right of the outline of the piece of FIG. 8.

With reference to FIG. 1, a machine 1 for working and/or moving sheets metal and/or metal plates according to the invention is partially and schematically shown, comprising operating means 2 capable of working and/or moving pieces 50, 51, 52 of sheet metal and/or metal plate, an artificial vision system 10 provided with one or more cameras 11 adapted to acquire or more images 20 of one or more pieces 50, 51, 52 positioned on a work plane 3 of the machine 1, and a control unit 5 connected to the operating means 2 and to the artificial vision system 10 and arranged to configure and/or adjust operating parameters to control the operating means 2, in particular based on geometric information of the piece.

The piece comprises, for example, metal sheet 50 or a metal plate, in particular of rectangular shape, or a semi-finished product 51 (i.e. a piece already partially processed, as shown in FIG. 1), or a scrap 52 of sheet metal or metal plate (obtained from previous working, as shown in FIG. 5).

In the embodiment shown in FIG. 1, the machine 1 is for example a machine for working, in particular for laser cutting, the pieces and the operating means 2 comprise a laser cutting head movable above the work plane 3, which is stationary, along three orthogonal axes XYZ of a reference system S of the machine (the origin of which is a defined reference point, for example on the work plane 3).

The artificial vision system 10 comprises one or more cameras 11, for example two, of known type and commercially available, configured to acquire at least one image 20 of the piece or pieces positioned on the work plane 3. A processing unit 12 is provided for processing the acquired image 20.

The processing unit 12 is connected to the cameras 11 and to the control unit 5 for transmitting thereto geometric information relating to the piece/pieces 50 and obtained by processing said image 20, as better explained in the following description.

The processing unit 12 can be separate and distinct from the control unit 5, for example associated with the artificial vision system 10, or can be embedded into the control unit 5, i.e. coincident with the latter, which acts as a processing unit 12 for the images 20 acquired by cameras 11.

The processing unit 12 is configured to process the image 20 acquired by the cameras 11 by means of a Deep Learning algorithm so as to identify and obtain a processed shape image 30 in which a shape 150 of the piece 50 having a respective contour 160 is represented. In the processed shape image 30, the shape 150 of the piece 50 obtained by the Deep Learning algorithm is superimposed on the image of the piece 50 acquired by the cameras (FIGS. 3 and 4).

‘Contour’ means the line or the set of straight and/or curved lines that limit and circumscribe an area defining the shape 150, i.e. the form processed by the Deep Learning algorithm that identifies and defines the piece 50.

It should be noted that these contour lines comprise the actual edges and/or corners of the piece, which define its extension, and lines that divide areas of the image having different intensity and/or colour.

The contour 160 comprises an outer contour of the piece (for example the two longer horizontal straight stretches or edges 160a and the two shorter vertical straight stretches or edges 160b of the sheet metal of FIGS. 2-5), but also inner contours that define already machined internal areas such as holes, openings and the like made in the piece (for example the openings made in the semi-finished product 51 of FIG. 1 and in the scrap 52 of FIG. 5).

The Deep Learning algorithm is an Artificial Intelligence algorithm of a known type, for example it is Google's DeepLab v3 algorithm, capable, after an appropriate training step, of identifying and recognizing pieces of different shapes and sizes and processing respective shapes or masks with identifiable contours or edges.

If the contour 160 of the shape 150 processed by the Deep Learning algorithm is precisely and completely defined and is entirely, i.e. in all its contour stretches 160a, 160b, distinguishable from a background of the processed shape image 30, i.e. from the work plane 3 (and therefore if said contour 160 can be recognized and identified completely and precisely), the processing unit 12 is able to recognize and identify one or more contour stretches 160a, 160b of said contour 160 of shape 150 and extract geometric information of the piece 50 on the basis of said identified contour stretches 160a, 160b.

As known, the contour or a contour stretch is accurately and distinguishably defined from the background of the image when any contour recognition algorithm of known type, e.g. a Canny algorithm or the like, succeeds in correctly and completely detecting, in an unambiguous manner, such contour or stretch, i.e. is able to complete successfully the recognition process.

On the contrary, if the contour 160 of the shape 150 processed by the Deep Learning algorithm is not precisely and completely defined (in particular when the Deep Learning algorithm roughly identifies the area of the image 20 of the piece 50 in which the material is depicted, but does not allow an edge recognition algorithm to accurately identify all the contour stretches), and comprises at least one stretch that is not distinguishable, or is poorly or scarcely distinguishable, from the background of the processed shape image 30, i.e. from the work plane 3 (and therefore said contour 160 cannot be accurately and completely recognized and identified), the processing unit 12 processes the image 20 previously acquired by the cameras 11 by means of a known contour recognition algorithm, for example a Canny algorithm or the like, so as to obtain a processed outline image 40 comprising an outline 260 of said piece 50. “Outline” 260 means the line or the set of straight and/or curved lines that limit and define the outer contour of the piece 50 and/or the inner contours of holes, openings and the like present in the piece.

The processing unit 12 is further configured to process the processed outline image 40 by means of mask means 15 that are applied to at least one portion of the processed outline image 40 containing at least one contour stretch 260a of the outline 260, which is not sufficiently precise, i.e. is not distinguishable or poorly distinguishable from the background of the processed outline image 40, i.e. from the work plane 3.

The portion of processed outline image 40 on which to apply the mask means 15 is identified using the shape 150 in the processed shape image 30, in particular the two processed images of the outline 30 and the shape 40 are superimposed. In other words, using the processed shape image 30 processed by the Deep Learning algorithm, it is possible to identify the portion or portions of the processed outline image 40 containing contour stretches 260a of outline 260 that are not sufficiently precise and distinguishable from the background, and on which the mask means 15 are to be applied in order to process the processed outline image 40 and recognise and identify said contour stretches 260a of the outline 260.

The mask means 15 therefore advantageously allow the contour stretch 260a of outline 260 circumscribed by them to be isolated, in particular with greater precision and definition, from the image background, i.e. the work plane 3, so that the processing unit 12 is able to precisely recognise and identify said contour stretch 260a of the outline 260.

In particular, the mask means 15 comprise one or more masks 16, in particular a plurality of masks 16 arranged aligned and regularly spaced along a detection line R, T and superimposable on the contour stretch 260a of the outline 260, in particular the contour stretch that is not precisely defined and not completely distinguishable, each mask 16 being defined by a closed flat curve, in particular ellipse or oval or circle shaped, which encloses a respective portion of said processed outline image 40 containing a respective portion of the contour stretch 260a.

As clearly shown in FIGS. 9, 10, 11a and 11b, which show masks 16 having, for example, an ellipse shape, this particular elliptical shape allows to better isolate contour stretches 260a of the outline that are substantially straight, imprecise and/or poorly distinguishable because they are partial and/or because the presence of other “disturbance” or “noise” stretches 261, 262 belonging, for example, to support elements of the work plane 3 (FIG. 9) and/or reflections and/or finishes of the surface of the piece 50 (FIG. 10), because the low contrast of the image. In particular, a contour stretch 260a that is horizontal (FIG. 11b) or inclined (FIG. 11a), even if flanked by a plurality of “noise” stretches, can be clearly and univocally recognised and identified.

FIG. 11c also shows a rectangular mask, which is not an object of the present invention, which however introduces at least two straight stretches, which form for example the two upper edges of the mask, which can be exchanged with the contour stretch actually searched.

A further advantage in the use of masks 16 having an elliptical shape lies in the shorter time required to process only the portions of the processed outline image 40 delimited by them compared to the time required to process the entire processed outline image 40.

The masks 16 of mask means 15 can be arranged along a horizontal detection line R and superimposed on lower 260a and upper 260b horizontal contour stretches of the outline 260 of the piece 50 (FIGS. 12a, 12b) and along a vertical detection line T and superimposed on left 260c and right 260d vertical contour stretches of the outline 260 of the piece 50 (FIGS. 12c, 12d).

The processing unit 12 is then able to extract geometric information relating to the piece 50 on the basis of one or more contour stretches 260a of the outline 260 recognised and identified in the processed outline image 40 by means of the mask means 15, with reference to the reference system S of the machine 1.

The geometric information includes at least distances and rotation angles of one or more of said contour stretches 160a, 160b, 260a of the contour 160 of the shape 150 or of the outline 260 recognized and identified in the processed images 30, 40 of the piece with reference to the reference system S.

The geometric information may also include the size of the one or more contour stretches, shape and size of the entire piece and/or position, orientation, shape and size of any internal areas of the (semi-finished) piece that have been worked, in particular openings, holes, slots, etc.

The processing unit 12 is configured to send the geometric information of the piece thus obtained to the control unit 5 of the machine 1 so as to configure and/or adjust the operating parameters of the operating means 2.

In particular, the geometric information extracted from the artificial vision system 10 allows the control unit 5 to calculate precisely a position and an orientation of each piece 50 arranged on the work plane 3 with respect to the reference system S of the machine 1.

“Position” of the piece means, for example, a distance of a reference point of the piece from origin of the reference system S of the machine along two orthogonal axes X, Y, while “orientation” of the piece means an angle formed by a reference stretch of the contour of the piece with one of the two axes of the reference system.

The operation of the machine 1 can be described by the various steps that define the method the invention for working sheets metal and metal plates described below.

The method according to the invention for working sheets metal and/or metal plates in a machine 1 provided with operating means 2 for working and/or moving pieces 50, 51, 52 of sheet metal and/or metal plate, an artificial vision system 10 for acquiring images 20 of at least one piece 50, 51, 52 and a control unit 5 for controlling the operating means 2 and connected to the artificial vision system 10, comprises the steps of:
positioning at least one piece 50, 51, 52 to be worked on a work plane 3 of the machine 1;
acquiring at least one image 20 of the piece 50, 51, 52 using at least one camera 11 of the artificial vision system 10;
processing the image 20 by means of a Deep Learning algorithm so as to identify and obtain a processed shape image 30 containing a shape 150 of said piece 50, 51, 52 having a respective contour 160;
if the contour 160 of the shape 150 in the processed shape image 30 is precisely and completely defined and is entirely distinguishable from a background of the processed shape image 30, i.e. from the work plane 3, recognizing and identifying at least one contour stretch 160a, 160b of the contour 160; or
if the contour 160 of the shape 150 in the processed shape image 30 is not precisely and completely defined and comprises at least one contour stretch which is indistinguishable, i.e. poorly or scarcely distinguishable, from the background of the processed shape image 30, then
   processing the image 20 by means of a contour recognition algorithm and obtaining a processed outline image 40 comprising an outline 260 of the piece 50, 51, 52, and
   processing the processed outline image 40 by means of mask means 15 applied to at least one portion of the processed outline image 40 containing at least one contour stretch 260a, 260b, 260c, 260d of the outline 260, in particular not distinguishable from a background of said processed outline image 40, and identified on the basis of the shape 150 in the processed shape image 30, in particular by superimposing the processed shape image 30 and the processed outline image 40, so as to precisely isolate the contour stretch 260a of the outline 260 that is circumscribed by the mask means 15 from the background, in order to recognize and identify the contour stretch 260a, 260b, 260c, 260d of the outline 260;
extracting geometric information of the piece 50, 51, 52 based at least on the contour stretch 160a, 160b; 260a, 260b, 260c, 260d of the contour 160 or of the outline 260 that is recognized and identified in the processed shape image 30 or in the processed outline image 40 by means of the mask means 15 and with reference to a reference system S of the machine 1;
sending the geometric information to the control unit 5 and configuring and/or adjusting operating parameters of the operating means 2.

In particular, the contour 160 of the shape 150 and/or the outline 260 relative to the piece 50 comprise respective pluralities of contour stretches 160a, 160b, 260a, 260b, 260c, 260d, in particular substantially rectilinear.

The geometric information comprises distances and rotation angles of one or more contour stretches 160a, 160b, 260a, 260b, 260c, 260d of the contour 160 or of the outline 260 with reference to the reference system S of the machine 1.

The method further comprises calculating a position and an orientation of the piece 50 positioned on the work plane 3 with respect to the reference system S on the basis of the geometric information extracted from the analysis of the contour of the piece recognized and identified in the processed shape image 30 or in the processed outline image 40 by means of the mask means 15.

The used mask means 15 comprise in particular at least one mask 16, formed by a closed flat curve, in particular ellipse or oval or circle shaped, which encloses the portion of the processed outline image 40 containing a respective portion of the contour stretch 260a, 260b, 260c, 260d to be recognized and identified.

In particular, the mask means 15 comprise a plurality of masks 16, each of which has the shape of an ellipse or an oval or a circle, that are arranged aligned and regularly spaced along detection line R, T and superimposable on a defined contour stretch 260a of the outline 260.

According to the method of the invention, it is also provided to acquire the image 20 of the piece 50 by superimposing two partial images acquired by two respective cameras 11 of the artificial vision system 10.

The piece to be worked positioned on the work plane 3 comprises a sheet metal 50, a metal plate, a semi-finished piece 51, a scrap 52 of metal sheet or metal plate.

Thanks to the machine and method for working sheets metal and/or metal plates of the invention by using an artificial vision system 10 provided with cameras 11 and a processing unit 12 (for example the same control unit 5 of the machine 1) it is therefore possible to determine in a precise, accurate and automatic manner, without intervention of operators, geometric information of the pieces positioned on the work plane 3 of the machine 1, in particular their position and orientation with respect to a reference system S of the machine 1, and on the basis of this geometric information to configure and/or adjust operating parameters of the operating means 2 that work and/or move the pieces 50, 51, 52.

In particular, by using a Deep Learning algorithm it is possible to process an image 20 of each piece 50, acquired by the cameras 11, and obtain a processed shape image 30 comprising a shape 150 of the piece 50 from which to directly extract, i.e. recognize and identify, the contour 160 and then extract the geometric information of the piece 50 (distances and rotation angles of various contour stretches 160a, 160b of the contour 160 with reference to reference system S of the machine 1) in order to configure and/or adjust the operating parameters of the operating means 2, without requiring a manual intervention by the operator.

It should be noted that the time required for the Deep Learning algorithm to process the image and extract the contour 160 of the piece is less than the time required for a contour recognition algorithm of a known type for recognizing and identifying said contour in the image.

Alternatively, in the event that the contour 160 of the shape 150 of the piece 50 in the processed shape image 30 obtained by the Deep Learning algorithm is not sufficiently defined and distinct to allow its direct recognition and identification, this contour 160 and the relative shape 150 can be advantageously used to identify a portion of the processed outline image 40 (obtained by processing the image 20 with a contour recognition algorithm) on which to apply the mask means 15 in order to better recognize and identify a contour stretch 260a of the outline 260 of the piece 50 contained in said portion of the processed outline image 40, also in this case without the need for manual intervention by an operator.

It is also possible to determine position and orientation on the work plane 3 of the machine of pieces comprising sheets metal 50, metal plates, semi-finished products 51, scrap or skeletons 52 of sheet metal or metal plates since corresponding drawings or reference figures are not required for recognition and identification of the contours of the pieces.

It is also possible to determine by means of the Deep Learning algorithm the internal contours of a piece that define already worked internal areas such as holes, openings and the like.

A variant of the machine for working sheets metal and/or metal plates of the invention is provided that differs from the embodiment described above in that the processing unit 12 is configured to process the image 20 acquired by the at least one camera 11 by means of a contour recognition algorithm so as to obtain a processed outline image 40 comprising an outline 260 of the piece 50.

The processing unit 12 is also configured to process the processed outline image 40 by means of mask means 15 applied to at least one portion of the processed outline image 40 containing at least one contour stretch 260a, in particular substantially rectilinear, of the outline 260, in particular not distinguishable or poorly distinguishable from a background of the processed outline image 40, i.e. from the work plane 3. The mask means 15 comprise at least one mask 16 defined by a closed flat curve, in particular ellipse or oval or circle shaped, which encloses the portion of the processed outline image 40 containing the contour stretch 260a so as to isolate and highlight said contour stretch 260a from the background of the processed outline image 40.

The processing unit 12 is also configured to recognize and identify the contour stretch 260a of the outline 260, extract geometric information of the piece 50 based at least on the contour stretch 260a of the outline 260 recognized and identified in the processed outline image 40 and with reference to a reference system S of the machine 1, and send the geometric information to the control unit 5 in order to configure and/or adjust operating parameters of the operating means 2 arranged to perform at least one established working on and/or moving of the piece 50.

The processing unit 12 is also configured to identify the portion of the processed outline image 40 on which to apply the mask means 15 on the basis of instructions manually provided by an operator or on the basis of a shape 150 of the piece 50 having a respective contour 160, shown in a processed shape image 30 obtained by processing the image 20 by means of an image recognition algorithm.

In particular, the portion of the processed outline image 40 on which to apply the mask means can be indicated by the operator by selecting on a screen of a control panel of the machine, connected to the control unit 5 and to the processing unit 12, one or more areas of the screen, which the processed outline image 40 is shown, corresponding to the portion of the processed outline image 40 to be identified.

Alternatively, a Deep Learning algorithm can be used as an image recognition algorithm to process the image 20 acquired by the cameras 11 and identify and obtain the processed shape image 30 containing the shape 150 of the piece 50 having a respective contour 160.

The operation of this variant of machine 1 of the invention can be described by the various steps defining the method of the invention for working and/or moving sheets metal and metal plates described below.

The method according to the invention for working and/or moving sheets metal and/or metal plates in a machine 1 provided with operating means 2 for working and/or moving pieces 50, 51, 52 of sheet metal and/or metal plate, an artificial vision system 10 for acquiring images 20 of at least one piece 50, 51, 52 and a control unit 5 for controlling the operating means 2 and connected to the artificial vision system 10, comprises the steps of:
positioning at least one piece 50, 51, 52 to be worked on a work plane 3 of the machine 1;
acquiring at least one image 20 of the piece 50, 51, 52 using at least one camera 11 of the artificial vision system 10;
processing the image 20 by means of a contour recognition algorithm and obtaining a processed outline image 40 comprising an outline 260 of the piece 50, 51, 52;
processing the processed outline image 40 by means of mask means 15 applied to at least one portion of the processed outline image 40 containing at least one contour stretch 260a, in particular substantially rectilinear, of the outline 260, in particular not distinguishable from a background of the processed outline image 40, the mask means 15 comprising at least one mask 16 defined by a closed flat curve, in particular ellipse or oval or circle shaped, enclosing the portion of the processed outline image 40 containing the contour stretch 260a so as to isolate and highlight the contour stretch 260a from the background of the processed outline image 40, i.e. from the work plane 3;
recognizing and identifying the contour stretch 260a of the outline 260;
extracting geometric information of the piece 50, 51, 52 on the basis of at least the contour stretch 260a of the outline 260 recognized and identified in the processed outline image 40 and with reference to a reference system S of the machine 1;
sending the geometric information to the control unit 5 for configuring and/or adjusting operating parameters of the operating means 2.

The outline 260 comprises a plurality of contour stretches 260a, 260b, 260c, 260d, in particular substantially straight, and processing the processed outline image 40 by the mask means 15 comprises applying the mask means 15 to each of the plurality of contour stretches 260a, 260b, 260c, 260d.

The mask means 15 comprise a plurality of masks 16, each of which is defined by a closed flat curve, in particular ellipse or oval or circle shaped, that are arranged aligned and regularly spaced along a detection line R, T and superimposable on a contour stretch 260a, 260b, 260c, 260d of the outline 260.

The geometric information of the piece 50 includes distances and rotation angles of one or more contour stretches 260a, 260b, 260c, 260d of the outline 260 with reference to the reference system S.

The method further comprises calculating a position and an orientation of the piece 50 positioned on the work plane 3 with respect to the reference system S on the basis of the geometric information extracted from the analysis of the contour of the piece that is recognized and identified in the processed outline image 40 by means of the mask means 15.

The method includes identifying the portion of the processed outline image 40 on which to apply the mask means 15 based on instructions manually provided by an operator or based on a shape 150 of the piece 50 having a respective contour 160 and represented in a processed shape image 30 obtained by processing the image 20 by means of an image recognition algorithm.

Advantageously, the image recognition algorithm is a Deep Learning algorithm adapted to process the image 20 and identify and obtain the processed shape image 30 containing a shape 150 of the piece 50 having a respective contour 160.

According to the method of the invention, it is also provided to acquire the image 20 of the piece 50 by superimposing two partial images acquired by two respective cameras 11 of the artificial vision system 10.

The piece to be worked positioned on the work plane comprises a sheet metal 50, a metal plate, a semi-finished product 51, a scrap 52 of sheet metal or metal plate.

Using the variant of machine and method for working sheets metal and/or metal plates of the invention, it is possible to accurately determine geometric information of the pieces 50, 51, 52 positioned on the work plane 3 of the machine 1, in particular their position and orientation with respect to a reference system S of the machine 1, and on the basis of this geometric information it is possible to configure and/or adjust operating parameters of the operating means 2 that work and/or move the pieces.

In particular, the mask means 15, which comprise a plurality of masks 16 in the shape of an ellipse and arranged aligned and regularly spaced along a detection line R, T, that are applied at a portion of the processed outline image 40 obtained by processing the image 20 acquired by the cameras 11 by means of a contour recognition algorithm, allow precisely and quickly recognizing and identifying contour stretches 260a of the outline 260 even if poorly defined and poorly distinguishable from the background as shown in FIGS. 10-12. The portion or portions of the processed outline image 40 on which the masks 16 are applied can be identified either on the basis of instructions manually provided by an operator acting on the machine control panel or, advantageously, on the basis of a shape 150 of the piece 50 represented in a processed shape image 30 obtained by processing the same image 20 of the piece 50 by means of an image recognition algorithm, in particular a Deep Learning algorithm.

Based on contour stretches 260a, 260b, 260c, 260d of the outline 260 thus recognized and identified in the processed outline image 40, it is possible to extract precise and accurate geometric information of the piece 50 that allows calculating its position and orientation on the work plane 3 with respect to the reference system S.

Therefore, it is possible to determine position and orientation on the work plane 3 of the machine 1 of pieces comprising sheet metal 50, metal plates, semi-finished products 51, scrap or skeletons 52 of sheet metal or metal plates since no corresponding drawings or reference figures are required for recognition and identification of contours of the pieces.

1-29. (canceled)

30. A machine for at least one between working and moving at least one between sheets metal and metal plates, comprising:
an operating system for at least one between working and moving pieces of at least one between sheet metal and metal plate;
an artificial vision system provided with at least one camera capable to acquire at least one image of at least one piece positioned on a work surface of said machine; and
a control unit to control said operating system and connected to said artificial vision system;
wherein said machine comprises a processing unit configured for:
processing said image by means of a Deep Learning algorithm so as to identify and obtain a processed shape image comprising a shape of said piece having a respective contour;
recognizing and identifying at least one contour stretch of said contour, if said contour is precisely and completely delineated and is fully distinguishable from a background of said processed shape image; or
if said contour of said shape is not precisely and completely delineated and includes at least contour stretch that is not distinguishable from said background of said processed shape image,
processing said image by means of a contour recognition algorithm and obtain a processed outline image comprising an outline of said piece, and
processing said processed outline image by a mask arrangement applied to at least one portion of said processed outline image containing at least one contour stretch of said outline, said portion of said processed outline image being identified on the basis of said shape in said processed shape image by superimposing the processed shape image and the processed outline image, so as to precisely isolate said contour stretch of said outline that is circumscribed by said mask arrangement with respect to said background in order to recognize and identify said contour stretch of said outline;
extracting geometric information of said piece on the basis of said at least one contour stretch of said contour or said outline recognized and identified in said processed shape image or in said processed outline image and with reference to a reference system of said machine;
sending said geometric information to said control unit in order to configure and alternatively or additionally adjust operating parameters of said operating system.

31. The machine according to claim 30, wherein said geometric information comprises at least distances and rotation angles of one or more contour stretches of said contour or of said outline that is recognized and identified in said processed shape image or in said processed outline image with reference to said reference system.

32. The machine according to claim 30, wherein said mask arrangement comprises at least one mask formed by a closed plane curve which encloses said portion of said processed outline image containing a respective portion of said contour stretch.

33. The machine according to claim 30, wherein said mask arrangement comprises a plurality of masks, each of which formed by a closed plane curve, said masks being arranged aligned and regularly spaced along a detection line and superimposable on said contour stretch of said outline.

34. A method for at least one between working and moving at least one between sheets metal and metal plates in a machine provided with an operating system for at least one between working and moving pieces of at least one between sheet metal and metal plate, an artificial vision system to acquire images of at least one piece and a control unit to control said operating system and connected to said artificial vision system, said method comprising the steps of:
positioning at least one piece to be worked on a work surface of said machine;
acquiring at least one image of said piece using at least one camera of said artificial vision system;
processing said image by means of a Deep Learning algorithm so as to identify and obtaining a processed shape image containing a shape of said piece having a respective contour;
if said contour is precisely and completely delineated and is fully distinguishable from a background of said processed shape image, recognizing and identifying at least one contour stretch of said contour; or
if said contour of said shape is not precisely and completely delineated and includes at least contour stretch that is not distinguishable from said background of said processed shape image,
processing said image by means of a contour recognition algorithm and obtaining a processed outline image comprising an outline of said piece and
processing said processed outline image by a mask arrangement applied to at least one portion of said processed outline image containing at least one contour stretch of said outline and identified on the basis of said shape in said processed shape image by superimposing the processed shape image and the processed outline image, so as to precisely isolate said contour stretch of said outline that is circumscribed by said mask arrangement with respect to said background in order to recognize and identify said contour stretch of said outline;
extracting geometric information of said piece on the basis of at least said contour stretch of said contour or of said outline that is recognized and identified in said processed shape image or in said processed outline image and with reference to a reference system of said machine;
sending said geometric information to said control unit and configuring and additionally or alternatively adjusting operating parameters of said operating system.

35. The method according to claim 34, wherein at least one between said contour and said outline comprises a plurality of contour stretches.

36. The method according to claim 34, comprising calculating at least a position and an orientation of said at least one piece on said work plane with respect to said reference system on the basis of said geometric information.

37. The method according to claim 34, wherein said mask arrangement comprises at least one mask formed by a closed plane curve which encloses said portion of said processed outline image containing a respective portion of said contour stretch.

38. The method according to claim 34, wherein said mask arrangement comprises a plurality of masks, said masks being arranged aligned and regularly spaced apart along a detection line and superimposable on said contour stretch of said outline.

39. A machine for at least one between working and moving at least one between sheets metal and metal plates, comprising:
an operating system for at least one between working and moving pieces of at least one between sheet metal and metal plate;
an artificial vision system provided with at least one camera capable to acquire at least one image of at least one piece positioned on a work surface of said machine; and
a control unit to control said operating system and connected to said artificial vision system;
wherein said machine includes a processing unit configured for:
processing said image by means of a contour recognition algorithm in order to obtain a processed outline image including an outline of said piece;
processing said processed outline image by a mask arrangement applied to at least one portion of said processed outline image containing at least one contour stretch of said outline, said mask arrangement comprising at least one mask formed by a closed plane curve which encloses said portion of said processed outline image so as to isolate and highlight said contour stretch from said background;
recognizing and identifying said contour stretch of said outline;
extracting geometric information of said piece on the basis of at least said contour stretch of said outline recognized and identified in said processed outline image and with reference to a reference system of said machine;
sending said geometric information to said control unit in order to configure and additionally or alternatively adjust operating parameters of said operating system.

40. The machine according to claim 39, wherein said geometric information comprises at least distances and rotation angles of one or more contour stretches of said outline that are recognized and identified in said processed outline image and with reference to said reference system.

41. The machine according to claim 39, wherein said mask arrangement comprises a plurality of masks, each of which formed by a closed plane curve, said masks being arranged aligned and regularly spaced along a detection line and superimposable on said contour stretch of said outline.

42. The machine according to claim 39, wherein said processing unit is configured to identify said at least one portion of said processed outline image on which to apply said mask arrangement on the basis of instructions manually provided by an operator or based on a shape of said piece having a respective contour, shown in an processed shape image obtained by processing said image by means of an image recognition algorithm.

43. A method for at least one between working and moving at least one between sheets metal and metal plates in a machine provided with an operating system for at least one between working and moving pieces of at least one between sheet metal and metal plate, an artificial vision system to acquire images of at least one piece and a control unit to control said operating system and connected to said artificial vision system, said method comprising the steps of:
positioning at least one piece to be worked on a work surface of said machine;
acquiring at least one image of said piece using at least one camera of said artificial vision system;
processing said image by means of a contour recognition algorithm and obtaining a processed outline image including an outline of said piece;
processing said processed outline image by a mask arrangement applied to at least one portion of said processed outline image containing at least one contour stretch of said outline, said mask arrangement comprising at least one mask formed by a closed plane curve which encloses said portion of said processed outline image so as to isolate and highlight said contour stretch from said background of said processed outline image;
recognizing and identifying said contour stretch of said outline;
extracting geometric information of said piece on the basis of at least said contour stretch of said outline recognized and identified in said processed outline image and with reference to a reference system of said machine;
sending said geometric information to said control unit in order to configure and additionally or alternatively adjust operating parameters of said operating system.

44. The method according to claim 43 wherein said outline comprises a plurality of contour stretches, said processing said processed outline image by said mask arrangement comprising applying said mask arrangement to each of said plurality of contour stretches.

45. The method according to claim 43, wherein said mask arrangement comprises a plurality of masks, each of which formed by a closed plane curve, said masks being arranged aligned and regularly spaced along a detection line and superimposable on said contour stretch of said outline.

46. The method according to claim 43, comprising calculating at least a position and an orientation of said at least one piece on said work plane with respect to said reference system on the basis of said geometric information.

47. The method according to claim 43, comprising identifying said at least one portion of said processed outline image on which to apply said mask arrangement based on of instructions manually provided by an operator or based on a shape of said piece having a respective contour shown in an processed shape image obtained by processing said image by means of an image recognition algorithm.

48. The method according to claim 47, wherein said image recognition algorithm is a Deep Learning algorithm configured to process said image and identify and obtain said processed shape image containing a shape of said piece having a respective contour.

49. The method according to claim 43, wherein said piece to be worked comprises one among sheet metal, metal plate, semi-finished product, sheet metal scrap or metal plate scrap.
